(19) United States
(12) Patent Application Publication
(10) Pub. No.: US 2026/0251834 A1
(43) Pub. Date: Aug. 27, 2026

(54) LIGHT GUIDE PLATE DESIGN FOR ASYMMETRIC LIGHTING

(71) Applicant: SIGNIFY HOLDING B.V., EINDHOVEN (NL)

(72) Inventors: HUAJIE LUO, SHANGHAI (CN); BO CAI, SHANGHAI (CN); ZHENYI ZHENG, SHANGHAI (CN); DI LOU, SHANGHAI (CN)

(21) Appl. No.: 18/875,874

(22) PCT Filed: Jun. 21, 2023
(86) PCT No.: PCT/EP2023/066876

§ 371 Date: Dec. 17, 2024

Related U.S. Application Data
(60) Provisional application No. 63/356,667, filed on Jun. 29, 2022.

(30) Foreign Application Priority Data
Jul. 12, 2022 (EP) 22184410.3

(51) Int. Cl. F21V 8/00

(52) U.S. Cl. CPC G02B 6/0016; G02B 6/0018; G02B 6/0073; G02B 6/0083; G02B 6/0091

(57) ABSTRACT

A lighting assembly (100) including a plurality of light sources (102), a light guide plate (106), a back reflector (110), a front collector (114), and a plurality of microstructures (124) is provided. The light sources are configured to generate light and are arranged on a PCB (118). The light guide plate (106) is arranged to receive the light generated by the light sources (102). The light guide plate (106) and the plurality of light sources (102) are separated by a gap (108). The back reflector (110) is arranged along a first surface (112) of the light guide plate (106). The front collector (114) is arranged below a second surface (116), opposite the first surface (112), of the light guide plate (106). The front collector (114) is also arranged across the gap (108) separating the light guide plate (106) from the plurality of light sources (102). The microstructures (124) are arranged on the first surface (112) of the light guide plate (106) and are arranged in a pattern to provide an asymmetric light distribution (200).

### FIELD OF THE DISCLOSURE

The present disclosure is directed generally to a light guide plate design for providing asymmetric lighting.

### BACKGROUND

Comfort is a key factor in implementing human-centric lighting in both indoor and outdoor applications. Applications which require asymmetric lighting, such as outdoor urban or road scenarios, currently rely on lens solutions. These lens solutions often use dot lenses or peanut lenses to achieve asymmetric light distribution, leading to pixilation on the emitting surface. Accordingly, when directly viewing the emitting surface of the luminaire, especially from the direction of peak intensity, the emitted light is accompanied by a significant glare, leading to discomfort for the viewer. This discomfort can be a significant safety hazard in outdoor applications, such as road lighting.

Alternatively, some current solutions utilize light guide plates, rather than lenses. These light guide plates typically utilize traditional techniques, such as laser dots printed on the plates. The techniques result in high degrees of non-uniformity, limiting their use in applications requiring uniform light. Accordingly, there is a need in the art for an optical design, such as a light guide plate, to realize side-lit asymmetric lighting, for example, in an outdoor or urban-style luminaire, with improved uniformity and reduced glare and pixilation.

### SUMMARY OF THE DISCLOSURE

The present disclosure is directed to a lighting assembly capable of producing asymmetric light with improved uniformity and reduced glare and pixilation compared to previous optical designs. This lighting assembly may be used in outdoor and urban applications, such as for lighting roads, sidewalks, and other outdoor infrastructure. Generally, the lighting assembly includes a plurality of light sources, such as light emitting diodes (LEDs), a printed circuit board (PCB), a light guide plate, a back reflector, and a front collector. The LEDs are arranged on the PCB. The light guide plate is arranged in close proximity to the LEDs, such that it receives light generated by the LEDs. The light guide plate is separated from the LEDs by a gap of air or other material having a different refractive index than the light guide plate. The light guide plate could be linear, circular, or any other appropriate shape. If the light guide plate is circular, the PCB may be flexible (i.e., an FPCB). The FPCB may be arranged around the circumference of the circular light guide plate in a full-circle or semi-circle configuration. Applicant has recognized and appreciated that the light guide plate design with three-dimensional texture as described herein can provide asymmetric lighting with improved uniformity and a light window that has a reduced or no amount of pixilation on its surface from any viewing angle.

As described herein, the back reflector is arranged above a top surface of the light guide plate such that it covers the LEDs. In one example, light generated by the LEDs travels through the light guide plate, reflects off of the back reflector, and exits the lighting assembly through a bottom surface of the light guide plate. The LED light then travels to the road or sidewalk positioned below the lighting assembly. The back reflector may be a specular, semi-specular, or non-specular reflector. Further, the back reflector could be composed of one or more sub-components. In further examples, a side reflector is arranged on a third surface of the light guide plate and substantially perpendicular to the back reflector. The side reflector is arranged opposite of the LEDs and PCB, such that it faces the LEDs from across the length of the light guide plate.

The front collector is configured to prevent light from escaping the lighting assembly via the gap between the LEDs and the light guide plate. The front collector is positioned below the bottom surface of the light guide plate such that it covers the LEDs. The front collector is used to reduce spottiness and/or brightness from the LEDs.

In order to provide asymmetrical light, the top surface of the light guide plate is textured with a pattern of three-dimensional microstructures. In some examples, each of the microstructures may be a symmetrical, oval-like shape. In some examples, one or more of the microstructures are filled with material having a different refractive index than the light guide plate and different microstructures can be filled with different materials having different refractive indices. In some examples, one or more of the microstructures are empty or vacant, i.e., without material. Further, one or more of the microstructures may have a rough surface, such as a roughness average (Ra) between approximately 0.1 and 20 micrometers. The microstructures may be arranged in a variety of different patterns on the top surface, such as circular or hexagonal or any suitable alternative. The circular structure may include a plurality of concentric rings, each ring comprising a portion of the plurality of microstructures. Further, the dimensions and rotational angle of each microstructure may be a function of the position of the microstructure on the top surface. For example, microstructures near the center of the top surface may be significantly larger than microstructures positioned near the outer edge of the top surface. Similarly, microstructures near the edge of the top surface may have a greater rotational angle than microstructures positioned near the center of the top surface. The pattern, placement, dimensions, and rotational angle of the microstructures are used to configure the directional angle of the light distribution provided by the light assembly.

Generally, in one aspect, a lighting assembly is provided. The lighting assembly includes a plurality of light sources. The plurality of light sources is configured to generate light. In one example, the plurality of light sources is arranged on a PCB.

The lighting assembly further includes a light guide plate. The light guide plate is arranged to receive the light generated by the plurality of light sources. The light guide plate and the plurality of light sources are separated by a gap. According to an example, the light guide plate is substantially circular or non-circular. Further to this example, the plurality of light sources is arranged in a circular or non-circular arrangement around the light guide plate.

The lighting assembly further includes a back reflector. The back reflector is arranged along a first surface of the light guide plate. According to an example, the back reflector is a specular reflector or a semi-specular reflector.

The lighting assembly further includes a front collector. The front collector is arranged below a second surface, opposite the first surface, of the light guide plate. The front collector is also arranged across the gap separating the light guide plate from the plurality of light sources. According to an example, the front collector is configured to reflect the light.

According to an example, the lighting assembly further includes a side reflector. The side reflector is arranged adjacent to the back reflector and a third surface of the light guide plate.

According to an example, the lighting assembly further includes a plurality of microstructures. The plurality of microstructures is arranged on the first surface of the light guide plate. In one example, each of the plurality of microstructures is defined by a rotational or non-rotational symmetric shape. Further, the rotational or non-rotational symmetric shape of a first microstructure of the plurality of microstructures may be scaled or stretched in at least one dimension relative to the rotational or non-rotational symmetric shape of a second microstructure of the plurality of microstructures.

According to an example, one or more dimensions of one of the plurality of microstructures corresponds to a position of the one of the plurality of the microstructures on the first surface of the light guide plate. In another example, a rotational angle of one of the plurality of microstructures corresponds to a position of the one of the plurality of the microstructures on the first surface of the light guide plate.

According to an example, the plurality of microstructures is arranged in a pattern comprising a plurality of concentric rings. The lighting assembly generates an asymmetric light distribution. A first microstructure of a first concentric ring of the plurality of concentric rings may be arranged at a different rotational angle than a second microstructure of the first concentric ring of the plurality of concentric rings.

According to an example, the plurality of microstructures is arranged in a hexagonal pattern. The lighting assembly may generate an asymmetric light distribution. A first microstructure of the hexagonal pattern may be arranged at a different rotational angle than a second microstructure of the hexagonal pattern.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

These and other aspects of the various embodiments will be apparent from and elucidated with reference to the embodiment(s) described hereinafter.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the various embodiments.

FIG. 1 is a cross-sectional view of a lighting assembly, according to aspects of the present disclosure.

FIG. 2 is a cross-sectional view of a lighting assembly for providing an asymmetric light distribution, according to aspects of the present disclosure.

FIG. 3A is a perspective view of a light guide plate with a microstructure positioned in the center of the light guide plate, according to aspects of the present disclosure.

FIG. 3B illustrates the x- and z-dimensions of the microstructure of FIG. 3A, according to aspects of the present disclosure.

FIG. 3C illustrates the y- and z-dimensions of the microstructure of FIG. 3A, according to aspects of the present disclosure.

FIG. 4A is a perspective view of a light guide plate with a microstructure offset from the center of the light guide plate, according to aspects of the present disclosure.

FIG. 4B illustrates the x- and z-dimensions of the microstructure of FIG. 4A, according to aspects of the present disclosure.

FIG. 4C illustrates the y- and z-dimensions of the microstructure of FIG. 4A, according to aspects of the present disclosure.

FIG. 5 illustrates a top view of a light guide plate with a plurality of microstructures arranged in a hexagonal pattern, according to aspects of the present disclosure.

FIG. 6 illustrates a top view of a light guide plate with a plurality of microstructures arranged in a plurality of concentric rings, according to aspects of the present disclosure.

FIG. 7 illustrates a cross-sectional view of a light guide plate with a plurality of microstructures of varying depths, according to aspects of the present disclosure.

FIG. 8A illustrates a top view of a lighting assembly, according to aspects of the present disclosure.

FIG. 8B illustrates a bottom view of a lighting assembly, according to aspects of the present disclosure.

FIG. 9 illustrates an exploded view of a lighting assembly, according to aspects of the present disclosure.

FIG. 10 illustrates a C-plane and a gamma angle, according to aspects of the present disclosure.

FIG. 11 illustrates magnified portions of the plurality of microstructures of a light guide plate, according to aspects of the present disclosure.

FIG. 12 is a light distribution graph of an example lighting assembly, according to aspects of the present disclosure.

FIG. 13 is an illuminance plot of an example lighting assembly, according to aspects of the present disclosure.

FIG. 14 illustrates a top view of a non-circular light guide plate with a plurality of microstructures arranged in a hexagonal pattern, according to aspects of the present disclosure.

### DETAILED DESCRIPTION OF EMBODIMENTS

The present disclosure is directed to a lighting assembly capable of producing asymmetric light with improved uniformity and reduced glare and pixilation compared to previous optical designs. This lighting assembly may be used in outdoor and urban applications, such as for lighting roads, sidewalks, and other outdoor infrastructure. Generally, the lighting assembly includes a plurality of light sources, such as light emitting diodes (LEDs), a printed circuit board (PCB), a light guide plate, a back reflector, and a front collector. The LEDs are arranged on the PCB. The light guide plate is arranged in close proximity to the LEDs, such that it receives light generated by the LEDs. The light guide plate is separated from the LEDs by a gap of air or other material having a different refractive index than the light guide plate. The light guide plate could be linear, circular, or any other appropriate shape. The back reflector is arranged above a top surface of the light guide plate such that it may cover the LEDs. In further examples, a side reflector is arranged on a side surface of the light guide plate. The side reflector is arranged opposite of the LEDs and PCB, such that it faces the LEDs. The front collector is configured to prevent light from escaping the lighting assembly via the gap between the LEDs and the light guide plate. The front collector is positioned below the bottom surface of the light guide plate such that it covers the LEDs. In order to provide asymmetrical light, the top surface of the light guide plate is textured with a pattern of three-dimensional microstructures. In some examples, each of the microstructures may be a symmetrical, oval-like shape. The microstructure may be arranged in a variety of different patterns on the top surface, such as radial or hexagonal.

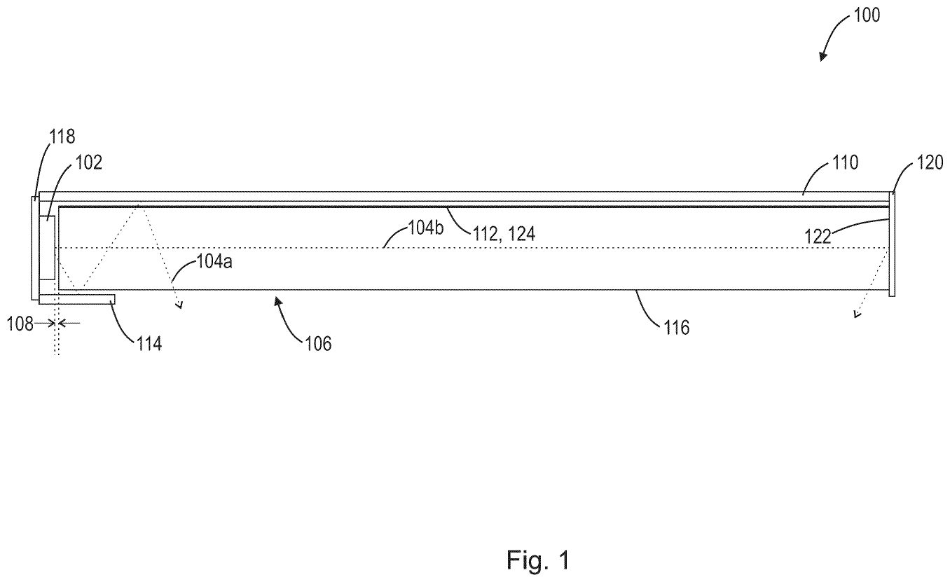

FIG. 1 is a cross-sectional view of a non-limiting example of a lighting assembly 100. The lighting assembly 100 includes a plurality of LEDs 102, a light guide plate 106, a back reflector 110, a front reflector 114, a PCB 118, and a side reflector 120. As shown in FIG. 1, the LEDs 102 emit light that exits out of the light guide plate 106. Light is shown for explanatory purposes and only two potential paths of light 104a, 104b are illustrated from LEDs 102 to the light guide plate 106. A person of ordinary skill in the art would understand that many more potential paths are possible additionally or alternatively. The LEDs 102 are mounted to PCB 118. In some examples, the PCB 118 is a flexible PCB (FPCB) configured to conform to the shape (circular, linear, etc.) of the light guide plate 106.

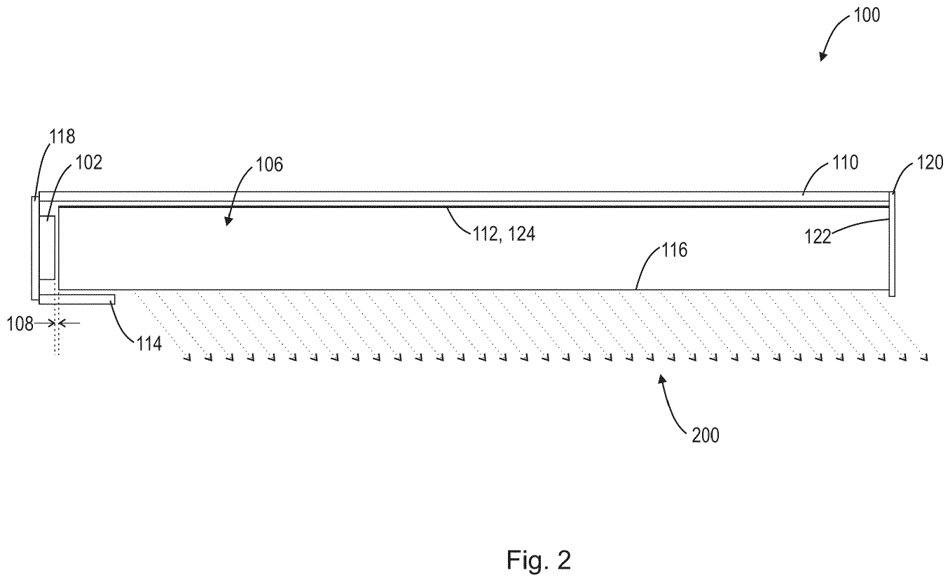

The light guide plate 106 is arranged proximate to the plurality of LEDs 102 and is configured to receive the light 104 generated by the LEDs 102. As shown in subsequent figures, the light guide plate 106 may be substantially circular, substantially semicircular, substantially linear, or any other appropriate shape. The light guide plate 106 may be defined by a first surface 112 defining the top of the light guide plate 106, a second surface 116 defining the bottom of the light guide plate 106, and a third surface 122 defining a side of the light guide plate 106 opposite of the LEDs 102 and PCB 118. The space between the LEDs 102 and the light guide plate 106 is defined by gap 108. As will be illustrated in subsequent figures, the light guide plate 106 includes a plurality of three-dimensional microstructures 124 on the first surface 112. The microstructures 124 are configured to convert the light 104a, 104b emitted by the LEDs 102 into an asymmetric light pattern 200 (see FIG. 2). Arranging the microstructures 124 on the first surface 112 breaks total internal reflection (TIR) or adjusts the TIR direction for the second surface 116 to enable downward light output.

A back reflector 110 is arranged along the first surface 112 of the light guide plate 106. The back reflector 110 is configured to reflect the light 104a, 104b emitted by the LEDs 102 substantially downwards toward the second surface 116 of the light guide plate 106. The back reflector 110 may be specular, semi-specular, or non-specular. In some examples, the back reflector 110 may be a single component 110. In other examples, the back reflector 110 may be an assembly of two of more sub-components, depending on overall mechanical and/or electrical design constraints. In a preferred example, the back reflector 110 covers both the first surface 116 of the light guide plate 106, the gap 108, and the upper most surface of the LEDs 102 to prevent light 104 from escaping out of the top of the lighting assembly 100. However, in other examples, the back reflector 110 may be separated from the PCB 118 by a second gap. This second gap may be required if the back reflector 110 is made of a metal material. To prevent light 104 from escaping through this second gap, an additional reflector may be used to cover the gap, such as a white, non-metal reflector. The example of FIG. 1 further includes a side reflector 120 configured to prevent light 104 from escaping out of the side of the lighting assembly 100 defined by the third surface 122 of the light guide plate 106. Accordingly, the side reflector 120 may be arranged adjacent to both the third surface 122 of the light guide plate 106 and the back reflector 110.

A front collector 114 is arranged below the second surface 116 and opposite the first surface 112. The front collector 114 is also arranged across the gap 108 separating the LEDs 102 from the light guide plate 106. In other words, there is a distance between first and second ends of the front collector 114 that is greater than the space within the gap 108. The front collector 114 prevents light 104 from escaping the lighting assembly 100 via gap 108. Thus, the front collector 114 hides spottiness or over-brightness due to light 104 escaping through the gap 108.

Light 104a illustrates one possible path light may take within the lighting assembly 100. Light 104a is emitted by one of the LEDs 102 and is directed downward. The front collector 114 then reflects the light 104a upwards. The back reflector 110 then reflects the light 104a downward and out of the lighting assembly 100 via the second surface 116 of the light guide plate 106.

Similarly, light 104b illustrates another possible path light may take within the lighting assembly 100. Light 104b is emitted by one of the LEDs 102 and is directed perpendicularly to LED 102. The side reflector 120 then reflects the light 104b downward and out of the lighting assembly 100 via the second surface 116 of the light guide plate 106. Following the reflection off the side reflector 120, the light 104b may be considered to be travelling around an optic axis of one of the LEDs 102.

FIG. 2 is a further cross-sectional view of a non-limiting example of a lighting assembly 100. FIG. 2 illustrates the asymmetric light distribution 200 generated by the light assembly 100 as a result of the microstructures 124 arranged on the first surface 112 of the light guide plate 106.

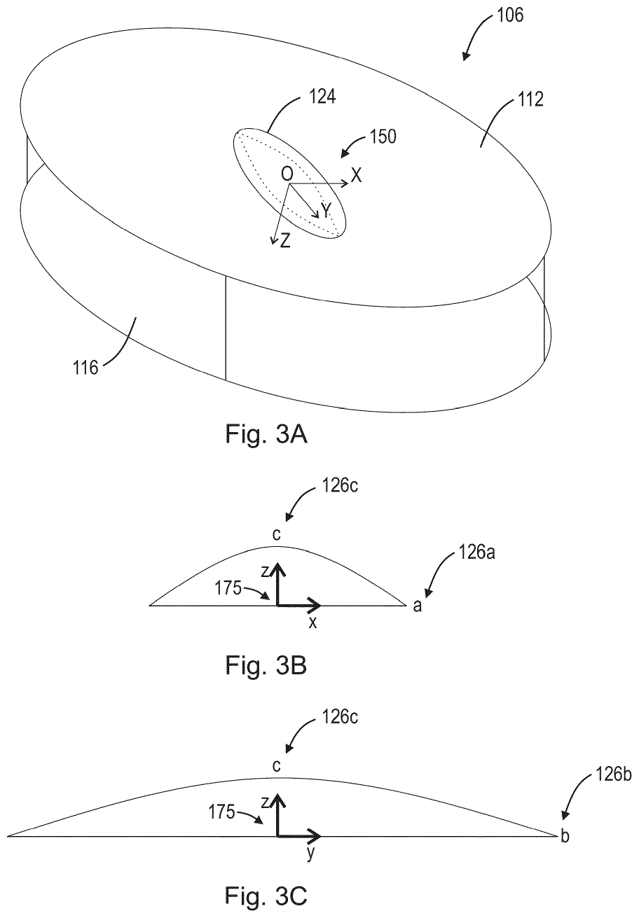

FIG. 3A illustrates a light guide plate 106 with a single three-dimensional microstructure 124 arranged on the first surface 112 for explanatory purposes. The position 134 of the microstructure 124 is defined according to light guide plate coordinate system 150. In this example, the position 134 of the microstructure 124 is the origin O of the light guide plate coordinate system 150.

FIGS. 3B and 3C define the dimensions of the microstructure 124 in the x-, y-, and z-directions according to a texture coordinate system 175. In this example, the microstructure 124 has a width 126a of a in the x-direction, a length 126b of b in the y-direction, and a depth 126c of c in the z-direction. In particular, FIGS. 3B and 3C demonstrate an example where a is greater than c but less than b. Other values for a, b, and c may be chosen depending on the desired characteristics of the asymmetric light distribution 200 provided by the lighting assembly 100 (see FIG. 2).

In the example of FIG. 3A, the microstructure 124 is reflectively symmetrical about its x-, y-, and z-axes. In other examples, the microstructure 124 may be rotationally symmetrical about a rotational angle. In further examples, the microstructure 124 may be entirely asymmetrical. In some examples, the microstructure 124 is filled with material having a different refractive index than the light guide plate 106. In some examples, the microstructure 124 is not filled with material having a different refractive index and is empty or vacant. Further, the microstructures 124 may have a rough surface, such as a roughness average (Ra) between approximately 0.1 and 20 micrometers.

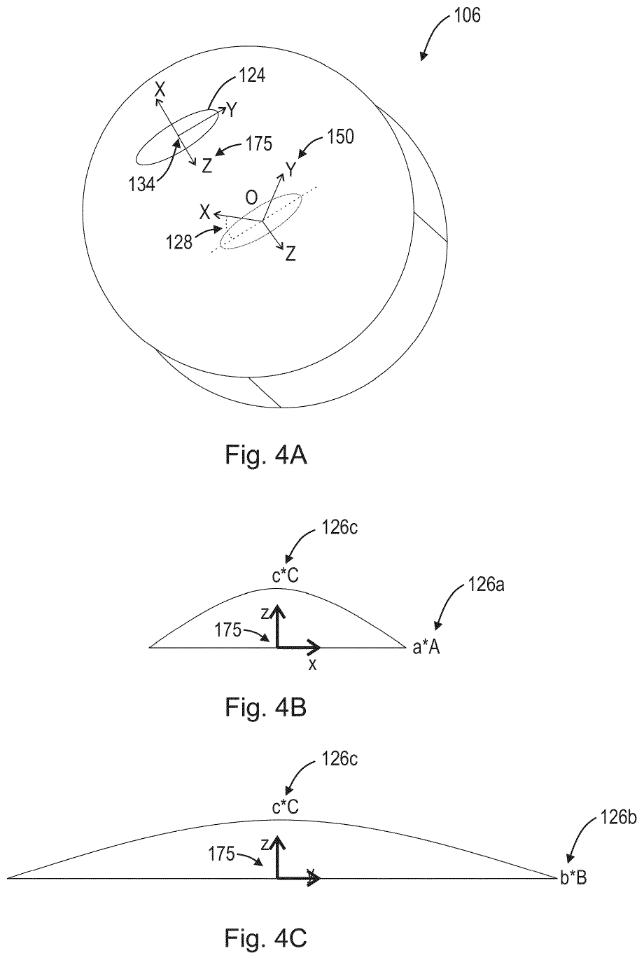

FIG. 4A illustrates a light guide plate 106 with a single three-dimensional microstructure 124 with a position 134 offset from the origin O of the light guide plate coordinate system 150. The microstructure 124 may also be defined by a rotational angle 128 relative to the x-axis of the light guide plate coordinate system 150. FIGS. 4B and 4C define the dimensions 126a, 126b, 126c of the microstructure in the x-, y-, and z-directions, respectively, according to a texture coordinate system 175. In these examples, the dimensions 126a, 126b, 126c and the rotational angle 128 are determined as a function of the position 134 of the microstructure 124.

In the examples of FIGS. 4A-4C, the coordinates of the light guide plate coordinate system 150 may be represented as (X_{g}, Y_{g}, Z_{g}), while the coordinates of the texture coordinate system 175 may be represented as (Xₜ, Yₜ, Zₜ). As shown in FIGS. 4B and 4C, the microstructure 124 has a width 126a of a*A in the x-direction, a length 126b of b*B in the y-direction, and a depth 126c of c*C in the z-direction. In some examples, a, b, and c may be fixed values for a certain shape (such as an ovoid), while the coefficients A, B, and C may be a function of the position 134 of the individual microstructure 124. In one example, A may be determined according to the following equation:

$$A ( {X}_{g} , {Y}_{g} ) = {A}_{1} + ( {A}_{g 1} * {X}_{g} ) + ( {A}_{g 2} * {Y}_{g} ) + ( {A}_{g 3} * {X}_{g}^{2} ) + ( {A}_{g 4} * {Y}_{g}^{2} ) \qquad ( 1 )$$

In the example of Equation 1, A₁, A_{g1}, A_{g2}, A_{g3}, and A_{g4} may be fixed values in a defined value range, such as [−20,20]. Similarly, B and C may be defined according to the following equations:

$$B ( {X}_{g} , {Y}_{g} ) = {B}_{1} + ( {B}_{g 1} * {X}_{g} ) + ( {B}_{g 2} * {Y}_{g} ) + ( {B}_{g 3} * {X}_{g}^{2} ) + ( {B}_{g 4} * {Y}_{g}^{2} ) \qquad ( 2 )$$

$$C ( {X}_{g} , {Y}_{g} ) = {C}_{1} + ( {C}_{g 1} * {X}_{g} ) + ( {C}_{g 2} * {Y}_{g} ) + ( {C}_{g 3} * {X}_{g}^{2} ) + ( {C}_{g 4} * {Y}_{g}^{2} ) \qquad ( 3 )$$

Similar to A₁, A_{g1}, A_{g2}, A_{g3}, and A_{g4}, the variables of B₁, B_{g1}, B_{g2}, B_{g3}, B_{g4}, C₁, C_{g1}, C_{g2}, C_{g3}, and C_{g4} may be fixed values in a defined value range, though the fixed values and the value ranges will likely be different than the A-fixed values.

Further, the rotational angle 128 may be defined according to the following equation:

$$θ ( {X}_{g} , {Y}_{g} ) = {θ}_{1} + ( {θ}_{g 1} * {X}_{g} ) + ( {θ}_{g 2} * {Y}_{g} ) + ( {θ}_{g 3} * {X}_{g}^{2} ) + ( {θ}_{g 4} * {Y}_{g}^{2} ) \qquad ( 4 )$$

Like the previous examples, the variables of θ₁, θ_{g1}, θ_{g2}, θ_{g3}, and θ_{g4} may be fixed values in a defined value range, such as [−90, 90].

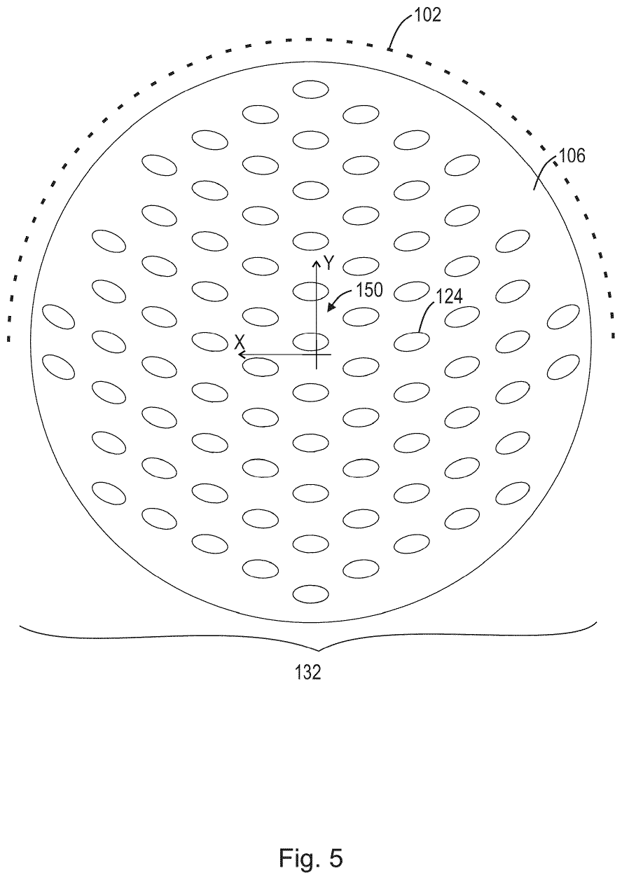

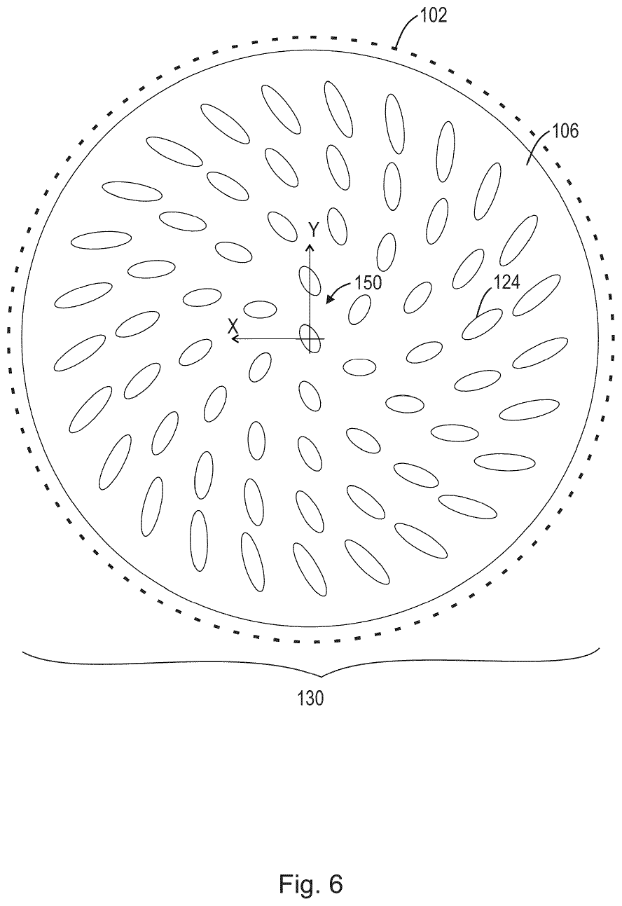

FIG. 5 illustrates a top view of a circular light guide plate 106 with a plurality of microstructures 124 arranged in a substantially hexagonal pattern 132 to generate an asymmetrical light distribution 200. In some examples, the microstructures 124 of the substantially hexagonal pattern 132 may vary in dimension 126 and rotational angle 128 based on their position 134 on the light guide plate 106. For example, while each of the microstructures 124 shown in FIG. 5 are identical, one or more of the microstructures 124 can differ in the x-, y-, and z-dimensions or rotation. In the example of FIG. 5, the fixed A, B, C, and θ values may be A₁₌₁, Ag₄=1.8, B₁=C₁=1, C_{g1}=−5, and θg₂=80, while all other fixed values are set to 0. Thus, the center column of microstructures 124 are arranged at a rotational angle 128 of approximately zero degrees. The microstructures 124 of the two columns adjacent to the center column are arranged at a rotational angle 128 slightly greater than zero degrees. Accordingly, the rotational angle 128 of the microstructures 124 is proportional to the distance of the position 134 of the microstructure 124 relative to the center column. A semi-circle of LEDs 102 is arranged around the outer edge of the light guide plate 106 in FIG. 5, while a full circle of LEDs 102 is arranged around the outer edge of the light guide plate 106 in FIG. 6.

FIG. 6 illustrates a top view of a further circular light guide plate 106 with a plurality of microstructures 124 arranged in a pattern comprising a plurality of concentric rings 130 to generate a symmetric light distribution. For example, there are six microstructures 124 surrounding the central microstructure in the FIG. 6. These six microstructures 124 form one concentric ring. As shown in FIG. 6, there are thirteen microstructures 124 surrounding the previous six microstructures forming another concentric ring and so on outward. In the example pattern shown in FIG. 6, there are four concentric rings formed around the central microstructure in the center. In some examples, the microstructures 124 of each of the concentric rings 130 may vary in dimension 126 and rotational angle 128 based on their position 134 on the light guide plate 106. As shown in FIG. 6, the microstructures 124 of each concentric ring 130 have approximately the same x-, y-, and z-dimensions. However, within each concentric ring 130, each microstructure has a unique rotational angle 128. Further the x-, y-, and z-dimensions of the microstructures 124 of one concentric ring 130 vary from the x-, y-, and z-dimensions of the microstructures from another concentric ring 130. Further, each concentric ring 130 includes a different number of microstructures 124. In the example of FIG. 6, the fixed A, B, C, and θ values may be A₁=1, A_{g3}=A_{g4}=1.8, B₁=C₁=1, C_{g1}=−5, and θ_{g1}=30, while all other fixed values are set to 0. A full circle of LEDs 102 is arranged around the outer edge of the light guide plate 106.

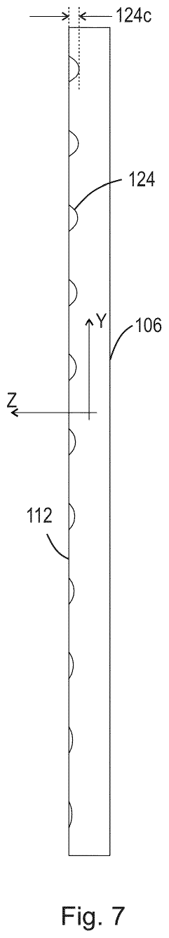

FIG. 7 illustrates a cross-sectional view of a light guide plate 106 having a plurality of microstructures 124 arranged on the first surface 112 of the light guide plate 106. As shown in FIG. 7, each row of microstructures 124 has a unique depth 126c. For example, the microstructure 124 shown at the top in FIG. 7 has the deepest depth and the microstructure at the bottom of FIG. 7 has the shallowest depth and each microstructure therebetween has a depth between the deepest and shallowest depths.

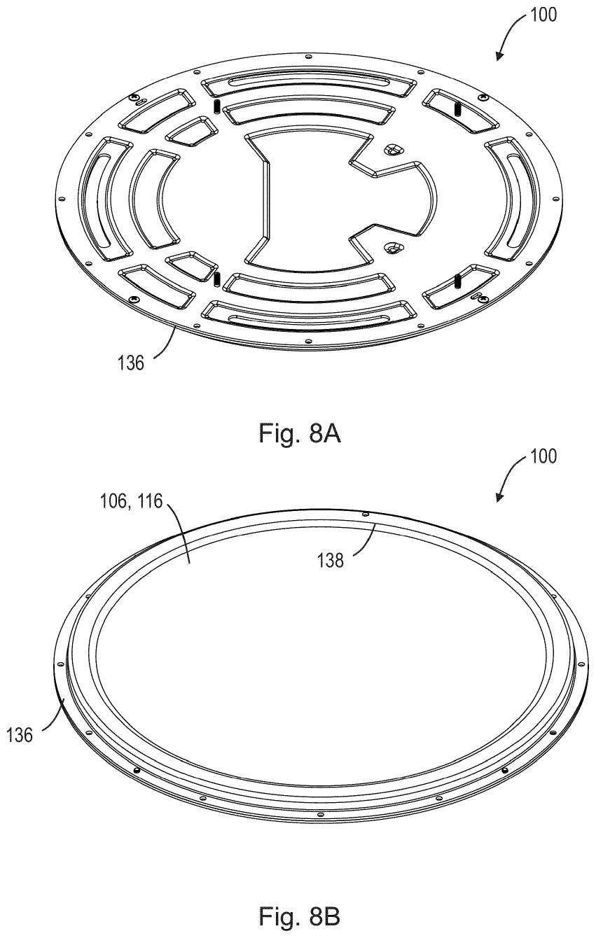

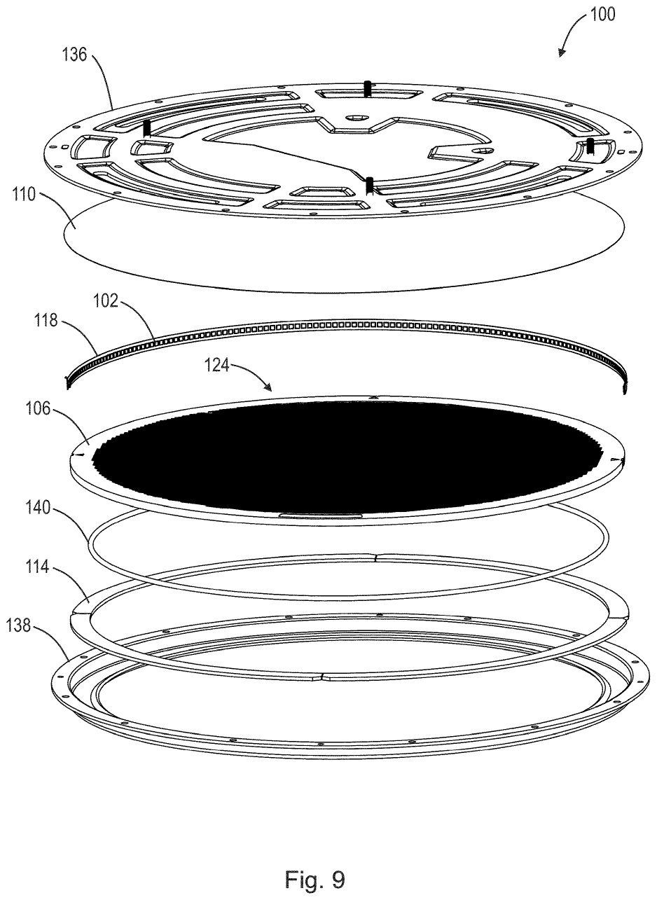

FIG. 8A is a top view of lighting assembly 100, while FIG. 8B is a bottom view of the same lighting assembly 100. FIG. 8A illustrates a circular top frame assembly 136. In other examples, the top frame assembly 136 may be a non-circular shape, such as a rectangular or linear shape. The top frame assembly 136 may include mounting holes for mounting the lighting assembly 100 to a lamppost, light pole, or other outdoor lighting structure via screws, bolts, or other appropriate means. FIG. 8B illustrates a bottom frame assembly 138. As will be demonstrated in FIG. 9, the bottom frame assembly 138 mechanically couples to the top frame assembly 136 to enclose the other components of the light assembly 100. Further, the bottom frame assembly 138 is hollow, exposing the second (bottom) surface 116 of the light guide plate 106.

FIG. 9 illustrates an exploded view of a non-limiting example of a lighting assembly 100. As shown in FIG. 9, the lighting assembly 100 includes a top frame assembly 136, a back reflector 110, a plurality of LEDs 102 arranged on a flexible, semicircular strip of PCB 118, a light guide plate 106 with a plurality of microstructures 124, an O-ring 140, a front collector 114, and a bottom frame assembly 138. The O-ring 140 is used to protect the components of the lighting assembly 100 arranged within the top frame assembly 136 and bottom frame assembly 138 from environmental conditions.

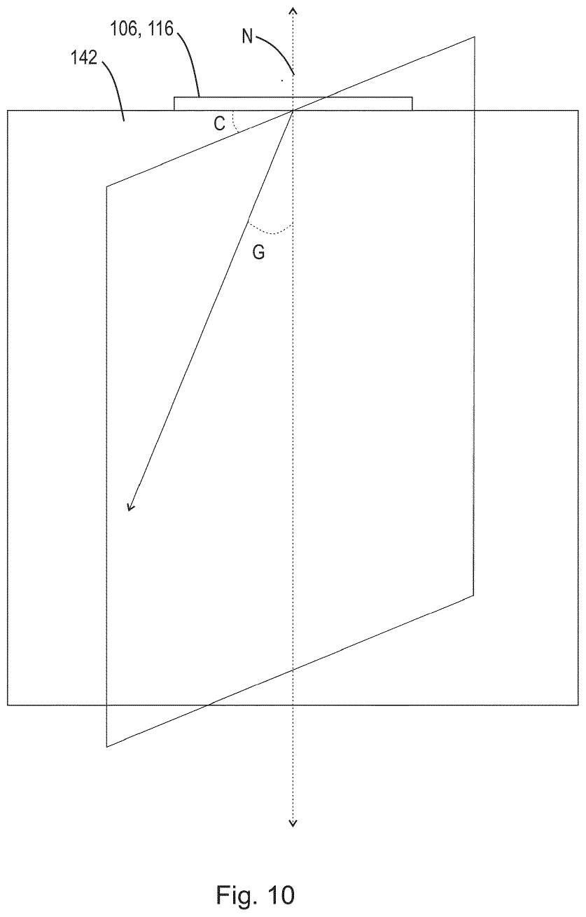

FIG. 10 illustrates an example spatial light distribution of a light assembly contemplated herein. Optically, the illustrated spatial light distribution is defined by a C-plane 142 and a gamma angle G. The normal line Nis directed vertical relative to the emitting surface 116 of the light guide plate 106. The normal line N can also be an imaginary line through a center of a luminaire. Any angle relative to the normal line N is defined as a gamma angle G. The C-plane 142 is arranged through the normal line N and relative to the second (bottom) emitting surface 116 of the light guide plate 106. In other words, the C-plane 142 is arranged along with the application or luminaire's longer direction. Any angle relative to the C-plane 142 is defined by C-plane angle C and the C-plane angle C is referred to as an amount of rotation about the normal line N. The asymmetric light distribution 200 generated by the lighting assembly 100 (see FIG. 2) is defined by the C-plane angle C and the gamma angle G. The intensity I of the asymmetric light distribution 200 can then be defined as a function of the C-plane angle C and the gamma angle G, for example, I(C, Gamma).

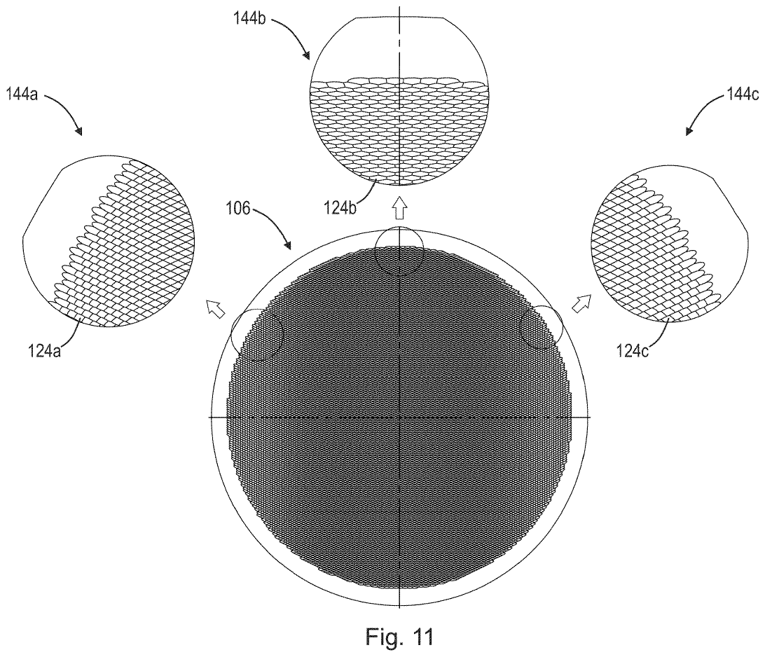

FIG. 11 illustrates magnified portions 144a, 144b, 144c of the plurality of microstructures 124a, 124b, 124c of a light guide plate 106. In particular, the magnified portions illustrate how the microstructures 124 vary in terms of both dimension 126 and rotational angle 128. In this way, the light guide plate 106 of FIG. 11 may be considered a real-world version of the light guide plate sown in FIG. 5. The dimensions 126 and rotational angle 128 of each of the microstructures 124 are defined based on equations (1)-(4) discussed herein which determine the dimensions 126 and rotation angle 128 based on the position 134 of each microstructure 124 and a number of pre-defined coefficients (A₁, A_{g1}, etc.). In first portion 144a, the microstructures 124a are arranged at an approximately −65-degree angle relative to normal line N (see FIG. 10). In second portion 144b, the microstructures 124b are arranged substantially parallel relative to normal line N. In third portion 144c, the microstructures 124c are arranged at an approximately 65-degree angle relative to normal line N. In this example, the coefficients used to configure each microstructure 124 are designed to achieve an asymmetrical light distribution 200 (see FIG. 2) for road lighting. Road lighting requires the lighting assembly 100 to illuminate a spacing defined by six times the mounting height of the lighting assembly 100 with a forward illumination field defined by 1.5 times the mounting height, and peak intensity when the C-plane angle C is 65-degrees. Referring to the microstructures 124 of FIGS. 4A-4C and Equations 1-4, when b is greater than a, θ_{g2} is approximately 65 degrees. Thus, the microstructures 124a, 124c are oriented in the direction of peak intensity.

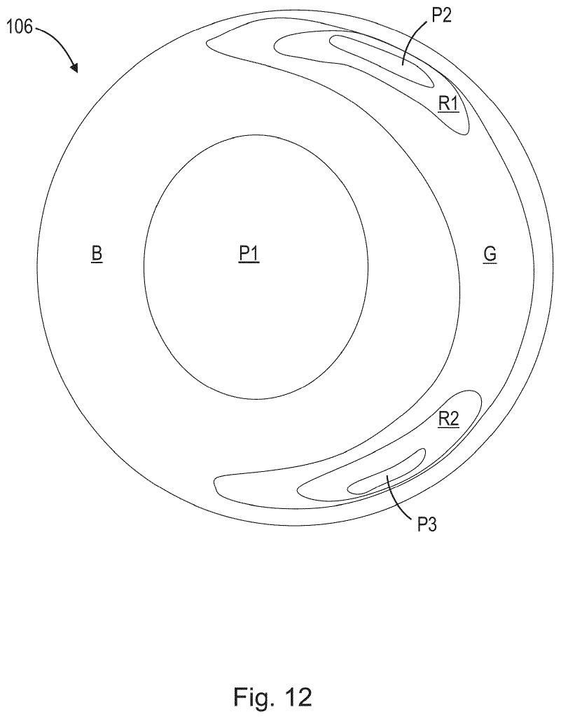

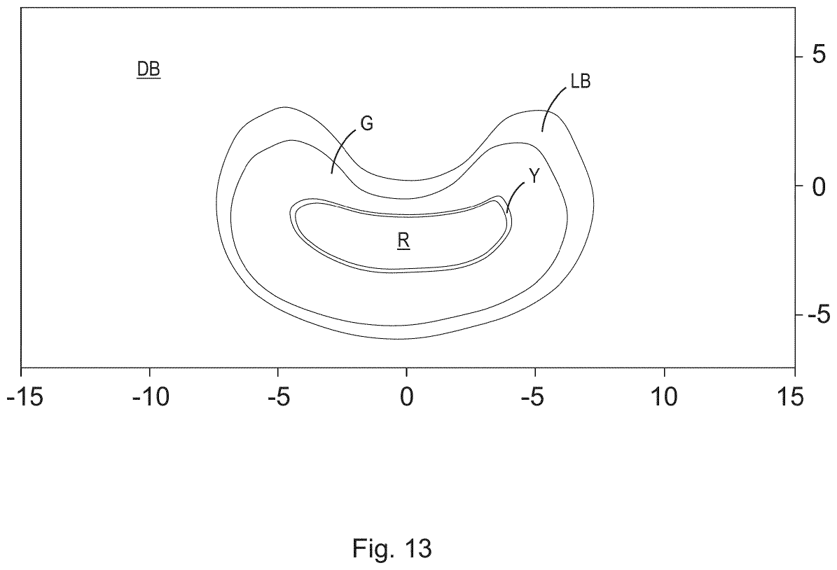

FIG. 12 is a light distribution graph of the example light guide plate 106 of FIG. 11. In FIG. 12, B refers to a blue region, G refers to a green region, R1 and R2 refer to red regions, and P1, P2, and P3 refer to purple regions. Further to this example, FIG. 13 is an illuminance plot corresponding to the example light guide plate 106 of FIG. 11. The illuminance plot shows the example light guide plate 106 as generating a bat-wing-shaped asymmetric light distribution 200 on a road. In this example, the lighting assembly 100 is mounted at a height of 6 meters, spaced 36 meters from other lights, and at a forward distance of 7.6 meters. This arrangement results in a ratio of average illuminance (Eₐᵥₑ) to minimum illuminance (Eₘᵢₙ) of 2.33, and a ratio of maximum illuminance (Eₘₐₓ) to Eₘᵢₙ of 4.22. Compared to traditional light guide plate solutions having Eₐᵥₑ:Eₘᵢₙ ratios of 4.5 and Eₘₐₓ:Eₘᵢₙ ratios of 11, the light guide plate 106 of FIG. 11 is a significant improvement over existing light guide plates used in road lighting applications.

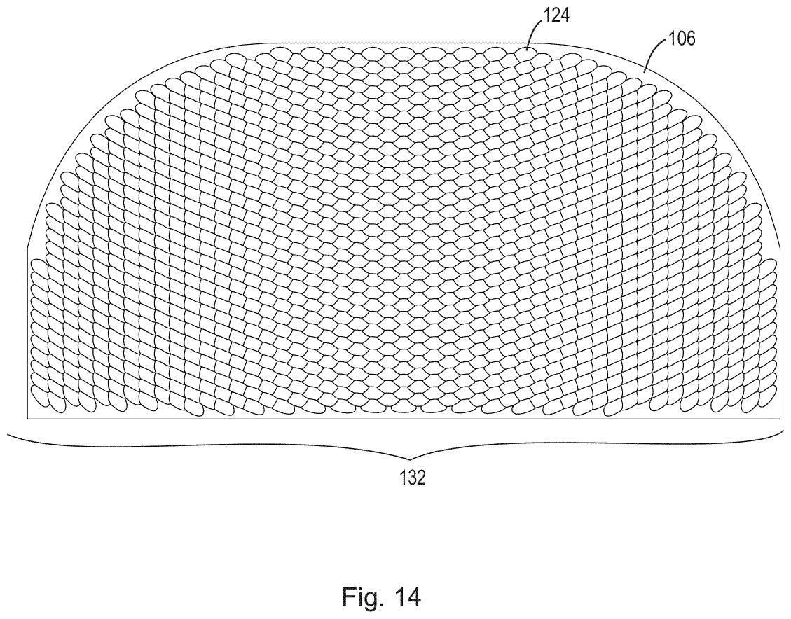

FIG. 14 illustrates a variation of the light guide plate of 106, where the light guide plate 106 is non-circular, rather than circular. In FIG. 14, the plurality of microstructures 124 are arranged in a semi-hexagonal pattern 132.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.”

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

Other implementations are within the scope of the following claims and other claims to which the applicant may be entitled.

While various examples have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the examples described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific examples described herein. It is, therefore, to be understood that the foregoing examples are presented by way of example only and that, within the scope of the appended claims and equivalents thereto, examples may be practiced otherwise than as specifically described and claimed. Examples of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

1. A lighting assembly, comprising:
a plurality of light sources configured to generate light;
a light guide plate arranged to receive the light generated by the plurality of light sources, wherein the light guide plate and the plurality of light sources are separated by a gap;
a back reflector arranged along a first surface of the light guide plate;
a front collector arranged below a second surface, opposite the first surface, of the light guide plate and across the gap separating the light guide plate from the plurality of light sources;
a plurality of microstructures arranged on the first surface of the light guide plate; and
wherein the lighting assembly generates an asymmetric light distribution.

2. The lighting assembly of claim 1, wherein the plurality of light sources is arranged on a printed circuit board (PCB).

3. The lighting assembly of claim 1, further comprising a side reflector arranged adjacent to the back reflector and a third surface of the light guide plate.

4. The lighting assembly of claim 1, wherein the back reflector is a specular reflector or a semi-specular reflector.

5. The lighting assembly of claim 1, wherein the front collector is configured to reflect the light.

6. The lighting assembly of claim 1, wherein the light guide plate is substantially circular or non-circular.

7. The lighting assembly of claim 1, wherein the plurality of light sources is arranged in a circular or non-circular arrangement around the light guide plate.

8. The lighting assembly of claim 1, wherein each of the plurality of microstructures is defined by a rotational or non-rotational symmetric shape; and wherein the rotational or non-rotational symmetric shape of a first microstructure of the plurality of microstructures is scaled or stretched in at least one dimension relative to the rotational or non-rotational symmetric shape of a second microstructure of the plurality of microstructures.

9. The lighting assembly of claim 1, wherein one or more dimensions of one of the plurality of microstructures corresponds to a position of one of the plurality of microstructures on the first surface of the light guide plate.

10. The lighting assembly of claim 1, wherein a rotational angle of one of the plurality of microstructures corresponds to a position of one of the plurality of the microstructures on the first surface of the light guide plate.

11. The lighting assembly of claim 1, wherein the plurality of microstructures is arranged in a pattern comprising a plurality of concentric rings.

12. The lighting assembly of claim 11, wherein a first microstructure of a first concentric ring of the plurality of concentric rings is arranged at a different rotational angle than a second microstructure of the first concentric ring of the plurality of concentric rings.

13. The lighting assembly of claim 1, wherein the plurality of microstructures is arranged in a hexagonal pattern and the lighting assembly generates an asymmetric light distribution.

14. The lighting assembly of claim 13, wherein a first microstructure of the hexagonal pattern is arranged at a different rotational angle than a second microstructure of the hexagonal pattern.
